(19) United States
(12) Patent Application Publication
(10) Pub. No.: US 2004/0210912 A1
(43) Pub. Date: Oct. 21, 2004

(54) Service interface for home network management

(76) Inventor: Michael Jeronimo, Wilsonville, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/417,613

(22) Filed: Apr. 16, 2003

(51) Int. Cl. G06F 9/46

(52) U.S. Cl. 719/328

(57) ABSTRACT

A service host platform in a Home Network providing a web service interface to an external network, interacting with an external network via the web service interface and managing the Home Network depending on data received by interacting with the external network.

### BACKGROUND

Home Networks found in many homes may include devices such as computers, telephones, home automation controllers, consumer electronics and consumer entertainment devices including music and video playback and recording systems. In a typical Home Network, these devices may be interconnected and be able to communicate with one or more other devices using some type of communication channel. The various modes of communication include packetized data transfer over cable and over radio and infrared frequencies. The physical infrastructure of Home Networks may include power line and phone line networking, 802.11 family wireless networking (See for example IEEE 802.11b standard for wireless local area networks, available at http://www.ieee.org), as well as 802.3 family Ethernet networking (See for example, IEEE 802.3 standard for Ethernet local area networks, available at http://www.ieee.org). Home Networks are also often connected via a suitable modem to an external network, typically the Internet, using a wide variety of carriers, including DOCSIS family carriers (see for example the Data Over Cable Service Interface Specification version 1.1, available at the Cable Labs web site, http://www.cablemodem.com/specifications) and the DSL family (see for example the Asymmetric Digital Subscriber Line Forum Reference Model, available at http://www.dslforum.org/aboutdsl/Technical_Reports/TR-001.pdf). Connectivity to the Internet allows a device on the Home Network to access resources available on the Internet. For example, a Digital Video Recorder (DVR) may download a television program schedule from a web site to enable scheduled recording of specific programs in accordance with a user's preferences.

Typically a Home Network does not provide any form of externally visible service to the Internet, such as a web server or an ftp server, in part because such access can be compromised, causing the devices of the Home Network and sensitive data belonging to a user of the network to become available to an unauthorized outside agent. Generally, therefore, access to the Home Network from the Internet is disfavored. In many instances gateway devices such as firewalls and network address translation (NAT) routers provide the interface between Home Networks and the Internet at the packet level. Typically firewalls in a Home Network are configured to block externally initiated access to the Home Network.

In the great majority of cases today, ordinary consumers are left to their own resources with some help from technical support staff when something goes wrong with the Home Network or when an upgrade is needed. As the set of devices in the home that is connected to the Home Network grows, so does the complexity of the network and therefore the difficulty of maintaining and servicing the network.

A set of protocols that allow remote management of devices and networks is available. These include among others, XML and SOAP. XML or the Extensible Markup Language, described at http://www.w3.org/XML/, is a simple text based language for transmitting information and meta-information. SOAP, or the Simple Object Access Protocol (SOAP) 1.1, described at http://www.w3.org/TR/SOAP, is a lightweight protocol for exchange of information in a decentralized, distributed environment. Universal Plug and Play (UPnP) is an architecture for pervasive peer-to-peer network connectivity of PCs and intelligent devices or appliances, particularly within the home. See http://www.UPnP.org.

### BRIEF DESCRIPTION OF THE DRAWINGS

FIG. 1 is a logical view of a Home Network and its interconnectivity with Service Providers in one embodiment of the claimed subject matter.

FIG. 2 is a logical view of an interaction between the service host and a device of the Home Network in one embodiment of the claimed subject matter.

### DETAILED DESCRIPTION

The claimed subject matter generally relates to the provision of web services hosted by a service host platform in a Home Network that interacts with service providers external to the home and manages the Home Network.

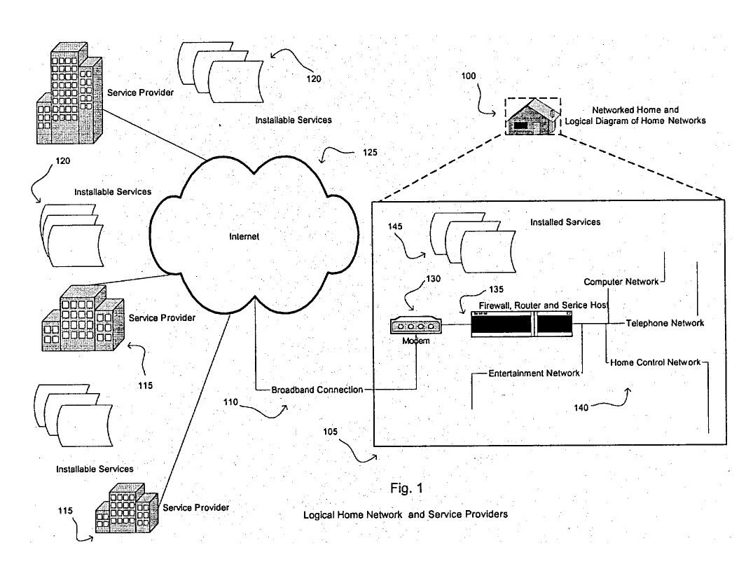

FIG. 1 shows a logical view of an embodiment of the claimed subject matter. The figure depicts an exemplary Home Network 105 within a home 100. The Home Network is connected via a modem 130 and a broadband connection 110 to the Internet 125. Such a connection to the Internet is widely known and practiced in the art, and many variations are possible for the provision of this broadband connection. In some instances a DOCSIS cable system may provide the high bandwidth interconnectivity of connection 110. In others, the broadband connection may be provided by DSL phone line. The specific type of broadband connection may vary in different embodiments of the claimed subject matter. Several service provider entities, or service providers 115, may be connected to the Internet as well. Each service provider is capable of providing services 120 that can be installed on the Home Network.

In this embodiment of the invention, the Home Network interfaces with the Internet using a firewall and NAT router 135. In other embodiments a router may be present without a firewall. The use of such routers to route data between the Internet and multiple devices on a Home Network is well known. Similarly, firewalls that allow selective blocking and filtering of the transmission of certain packet types or of packets with certain sources and/or destinations between the Internet and the Home Network are well known. Many variations of both routers and firewalls are possible in different embodiments.

The Home Network itself may include a variety of devices, such as computers, including laptop computers and desktop computers, or other processor based systems including for example wireless networking enabled personal digital assistants (PDAs); telephones and telephony devices such as answering systems and fax machines; entertainment devices such as digital audio and video playback and recording systems, among many others. In a Home Network, these devices may be interconnected and generally are accessible to at least some of the other devices on the network. In some embodiments, the router is capable of communicating with all of the devices on the Home Network.

The communications between devices of the Home Network may take place using a variety of well known protocols such as wired Ethernet based on the 802.3 set of standards, wireless connectivity based on the 802.11 family of standards or using other similar standards. Many protocols that allow communication between Home Network devices are well known in the art.

In the embodiment shown in FIG. 1, the router/firewall also serves as a service host platform or service host for the Home Network. A service host is a device that provides web services accessible from outside the Home Network, using, in some embodiments, protocols including XML, SOAP, and HTML. The service host manages the Home Network. Specifically, the service host may in some embodiments access devices on the Home Network, query them for status, modify configurations of the devices, update or install software on the devices, among other management actions. In other embodiments different protocols may be used or a device separate from the router/firewall may serve as the service host.

In one instance of these embodiments, a service provider may connect to the web service interface of a Home Network service host. It may then authenticate itself to the service module and then transmit an automatically installable service package for installation on the Home Network. This may occur, in one instance, because a user requested an upgrade to the firmware on a networked device such as a DVR to avail herself of new features released by its manufacturer.

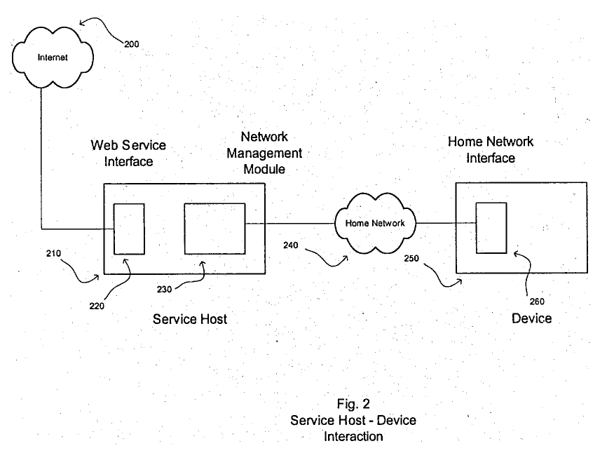

As shown in FIG. 2, the service package may then be transmitted to the service host 210 using the HTTP protocol over the Internet 200 via its interface 220. The service provider then may use the SOAP protocol to instruct the service host to install the service package on the network. Such instructions could include a method of identifying the device on the network where the installation is to occur. The service host may also identify the device based on its own internal data or by a pre-programmed process. The service host may also need to verify if the service package is compatible with other services on the network or on the device itself. For example, a software package may be installable only on certain operating systems. The service host may then invoke its Home Network management module 230 which may perform the installation in accordance with the instructions received from the server. The Service Host would communicate with the device 260 using Home Network connectivity 240. In the DVR example referred to above, the service host could then access the DVR to perform the upgrade to the firmware.

In another instance, the service host may receive new configuration information for a device from a service provider via its web service interface. This may occur, in one instance, if a viewer requests an upgrade to his satellite television decoder in order to view premium content. The service host's network management module in this case would alter the configuration of the decoder device to reflect the new access rights granted to the viewer via the decoder device's home network interface.

In addition to installation or upgrade of a service on the Home Network, the service host may also provide status information on the network to a service provider. This may allow maintenance or trouble shooting of problems occurring on the Home Network, alerts relating to hardware failures, and security alerts relating to malignant programs such as viruses or worms that may have been introduced to the Home Network. The service host itself may be monitored and maintained by the service, provider using its web service interface.

In addition to the SOAP/XML/HTTP implementation described, other implementations are possible in other embodiments. UPnP is a protocol that allows upgrade or installation of services over a network and may be used to access devices. Thus, the service provider could access Home Network devices directly with UPnP after authentication through the service host. Proprietary protocols may also be used in some embodiments if the service host is capable of transmitting these protocols.

The present invention includes various steps. The steps of the present invention may be performed by a machine such as a processor based device, or may be embodied in data which when accessed by a machine which may be used to cause a general-purpose or special-purpose processor or logic circuits programmed with the instructions to perform the steps. Alternatively, the steps may be performed by a combination of hardware and software. The present invention may be provided as a computer program product that may include a machine-readable medium having stored thereon data which when accessed by a machine, may cause the machine to perform a process according to the present invention. The machine-readable medium may include, but is not limited to, floppy diskettes, optical disks, DVD-ROM disks, DVD-RAM disks, DVD−RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

What is claimed is:

1. In a service host platform in a home network, a method comprising:
providing a web service interface to an external network;
interacting with an external network via the web service interface; and
managing the Home Network depending on data received by interacting with the external network.

2. The method of claim 1 further comprising:
receiving an installable service for the Home Network via the web service interface;
selecting at least one device on the Home Network for installation of the service; and
installing the service on the device.

3. The method of claim 2 further wherein the automatically installable service comprises an upgrade for a service previously installed on at least one device on the Home Network.

4. The method of claim 1 wherein managing the Home Network depending on data received comprises managing the Home Network depending on XML formatted data received using the HTTP protocol.

5. The method of claim 1 further comprising:
receiving configuration information from the external network; and
altering the configuration of at least one device on the Home Network in accordance with the configuration information.

6. The method of claim 5 further comprising changing the access settings for content accessible from a device on the Home Network.

7. At a service provider, method comprising:
interacting across an external network, with a web service interface of a service host platform of a Home Network; and
sending data to the service host platform via the web service interface for the management of the Home Network.

8. The method of claim 7 further comprising sending an automatically installable service for the Home Network via the web service interface to be installed on at least one device on the Home Network that is compatible with the service.

9. The method of claim 8 further wherein the automatically installable service comprises an upgrade for a service previously installed on at least one device on the Home Network.

10. The method of claim 7 further comprising
using the HTTP protocol to receive data; and
receiving data in the XML format.

11. The method of claim 7 further comprising sending configuration information to the service host platform to alter the configuration of at least one device on the Home Network in accordance with the configuration information.

12. The method of claim 11 further comprising sending configuration information to the service host platform to change the access settings for content accessible from a device on the Home Network.

13. A system comprising:
a Home Network including a service host platform;
a web service interface accessible form an external network, provided by the service host platform; and
a Home Network management module to manage the Home Network depending on data received by the service host platform over web service interface.

14. The system of claim 13 further comprising:
a service module to be installed on the Home Network and received by the service host platform via the web service interface
a device on the Home Network compatible with the service module the Home Network management module, further to identify the device and to install the service on the device.

15. A system comprising:
a Home Network including a service host platform;
a web service interface using the HTTP protocol accessible form an external network, provided by the service host platform; and
a Home Network management module to manage the Home Network depending on data received by the service host platform over web service interface, the data received being at least in part in the XML format.

16. A machine accessible medium comprising data that when accessed by a machine causes the machine to perform the method of claim 1.

17. The machine accessible medium of claim 16 comprising further data that when accessed by the machine causes the machine to perform the method of claim 2.

18. The machine accessible medium of claim 17 comprising further data that when accessed by the machine causes the machine to perform the method of claim 3.

19. The machine accessible medium of claim 16 comprising further data that when accessed by the machine causes the machine to perform the method of claim 4.

20. The machine accessible medium of claim 16 comprising further data that when accessed by the machine causes the machine to perform the method of claim 5.

21. The machine accessible medium of claim 20 comprising further data that when accessed by the machine causes the machine to perform the method of claim 6.

22. A machine accessible medium comprising data that when accessed by a machine causes the machine to perform the method of claim 7.

23. The machine accessible medium of claim 22 comprising further data that when accessed by the machine causes the machine to perform the method of claim 8.

24. The machine accessible medium of claim 23 comprising further data that when accessed by the machine causes the machine to perform the method of claim 9.

25. The machine accessible medium of claim 22 comprising further data that when accessed by the machine causes the machine to perform the method of claim 10.

26. The machine accessible medium of claim 22 comprising further data that when accessed by the machine causes the machine to perform the method of claim 11.

27. The machine accessible medium of claim 26comprising further data that when accessed by the machine causes the machine to perform the method of claim 12.
